(19) United States
(12) Patent Application Publication
(10) Pub. No.: US 2025/0262679 A1
(43) Pub. Date: Aug. 21, 2025

(54) Pipe Threading Device

(71) Applicant: Leonard Gregory, Brighton, CO (US)

(72) Inventor: Leonard Gregory, Brighton, CO (US)

(21) Appl. No.: 18/661,974

(22) Filed: May 13, 2024

Related U.S. Application Data
(60) Provisional application No. 63/555,417, filed on Feb. 20, 2024.

(51) Int. Cl. B23G 1/22

(52) U.S. Cl. CPC B23G 1/22

(57) ABSTRACT

A pipe threading device is provided. The device is comprised of an adapter that can be used to attach a die thread to an impact tool or similar tool. In another embodiment, the device is also comprised of a die thread. The adapter is comprised of a bottom member with multiple openings to accommodate different types and sizes of die threads, and at least one socket for attachment to a tool. The die thread, equipped with a thread-cutting member, is designed to cut threads into a pipe when rotated by the tool. This setup allows for the easy attachment of die threads to tools and facilitates the threading of pipes without manual operation.

### CROSS-REFERENCE TO RELATED APPLICATION

The present application claims priority to, and the benefit of, U.S. Provisional Application No. 63/555,417, which was filed on Feb. 20, 2024, and is incorporated herein by reference in its entirety.

### FIELD OF THE INVENTION

The present invention relates generally to the field of pipe threading devices. More specifically, the present invention relates to a pipe threading device that can be used to attach a die thread to an impact tool or other similar tool. Accordingly, the present disclosure makes specific reference thereto. Nonetheless, it is to be appreciated that aspects of the present invention are also equally applicable to other like applications, devices, and methods of manufacture.

### BACKGROUND

In situations where piping requires maintenance or modification, particularly when implementing conventional threading techniques, it becomes necessary to undertake significant preparatory work. This often involves the complete removal of piping that is embedded within or runs along critical structures such as walls, ceilings, and floors. The objective behind such a rigorous approach is to ensure unimpeded access to the pipe, facilitating the threading process without any structural impediments.

Moreover, the process is not limited to the removal of pipes alone. Any obstructions proximal to the piping, which could potentially hinder the threading process, must also be identified and removed. This step is crucial for maintaining the integrity and efficiency of the threading operation, ensuring that the pipes are threaded properly and securely.

Compounding the complexity of the task is the necessity for various specialized devices, which are often required to thread pipes effectively. These devices are typically used manually, which is undesirable and inefficient.

Threading pipe or conduit in confined or hard-to-reach areas amplifies these challenges exponentially. Tight spaces constrain the movement of machinery and personnel, making it incredibly difficult to carry out the threading process. Such conditions require careful planning and often innovative approaches to thread the pipes effectively, ensuring that the work is completed efficiently and safely, despite the spatial limitations.

Therefore, there exists a long-felt need in the art for an improved device for pipe threading. More specifically, there exists a long-felt need in the art for a pipe threading device that can be used to thread pipes in tight spaces. Further, there exists a long-felt need in the art for a pipe threading device that can be used to thread pipes in tight spaces wherein the device does not require significant physical exertion to use.

The subject matter disclosed and claimed herein, in one embodiment thereof, comprises a pipe threading device. The device is comprised of an adapter that can be used to attach a die thread to an impact tool or similar tool. In another embodiment, the device is also comprised of a die thread. The adapter is comprised of a bottom member with multiple openings to accommodate different types and sizes of die threads and at least one socket for attachment to a tool. The die thread, equipped with a thread-cutting member, is designed to cut threads into a pipe when rotated by the tool. This setup allows for the easy attachment of die threads to tools and facilitates the threading of pipes without manual operation.

In this manner, the pipe threading device of the present invention accomplishes all the foregoing objectives and provides an improved device for pipe threading. More specifically, the device can be used to thread pipes in tight spaces. While doing so, the device does not require significant physical exertion to use.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pipe threading device. In one embodiment, the device is comprised of an adapter that can be used to attach a die thread to an impact tool, drill, etc. As a result, the thread can be used to thread a pipe without having to manually operate the thread.

The adapter is comprised of a flat bottom member comprised of at least one opening. In the preferred embodiment, the bottom member has a plurality of openings of any size, spacing, arrangement, etc. The openings of the bottom member allow at least one fastener, such as, but not limited to, a screw or a bolt, to be placed through the opening and into at least one threaded opening of a die thread. In this manner, the die thread can be removably attached to the adapter.

The adapter is also comprised of at least one socket that extends from the bottom member that allows the adapter to attach to an impact tool, a drill, etc. In this manner, the tool can be used to rotate the thread around a pipe to thread said pipe to eliminate the need for a user to manually rotate the die thread around said pipe to achieve the same. The die thread is comprised of at least one opening that allows a pipe to be placed into the thread. The interior of the thread is comprised of at least one thread-cutting member of any thread pitch, size, configuration, etc. When rotated around a pipe, the member cuts threads into the pipe.

The present invention is also comprised of a method of using the device. First, a device is provided comprised of at least one fastener, at least one adapter comprised of at least one opening and at least one socket, a die thread comprised of at least one fastener opening, at least one opening, and at least one thread-cutting member. Then, the die thread can be attached to the adapter by placing the fastener through the opening of the adapter and securing the fastener into the opening of the die thread. Next, the socket can be used to attach the device to an impact socket, a drill, etc. Finally, a pipe end can be inserted into an opening of the die thread, wherein the impact tool can be spun to cause the thread to spin around the pipe end such that the thread-cutting member cuts at least one thread into the pipe end.

Accordingly, the pipe threading device of the present invention is particularly advantageous as it provides an improved device for pipe threading. More specifically, the device can be used to thread pipes in tight spaces. While doing so, the device does not require significant physical exertion to use. In this manner, the pipe threading device overcomes the limitations of existing pipe threading devices and methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective top view of an adapter of one potential embodiment of a pipe threading device of the present invention in accordance with the disclosed architecture;

FIG. 2 illustrates a perspective bottom view of an adapter of one potential embodiment of a pipe threading device of the present invention in accordance with the disclosed architecture;

FIG. 3 illustrates a perspective top view of a die thread of one potential embodiment of a pipe threading device of the present invention in accordance with the disclosed architecture;

FIG. 4 illustrates a side view of one potential embodiment of a pipe threading device of the present invention while attached to a tool in accordance with the disclosed architecture;

FIG. 5 illustrates a flowchart of a method of using one potential embodiment of a pipe threading device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved device for pipe threading. More specifically, there exists a long-felt need in the art for a pipe threading device that can be used to thread pipes in tight spaces. Further, there exists a long-felt need in the art for a pipe threading device that can be used to thread pipes in tight spaces wherein the device does not require significant physical exertion to use.

The present invention, in one exemplary embodiment, is comprised of a pipe threading device. In one embodiment, the device is comprised of an adapter that can be used to attach a die thread to an impact tool, drill, etc., such that the thread can be used to thread a pipe without having to manually operate the thread.

More specifically, the adapter is comprised of a flat bottom member comprised of at least one opening. In the preferred embodiment, the bottom member has a plurality of openings of any size, spacing, arrangement, etc., that allows at least one fastener, such as, but not limited to, a screw or a bolt, to be placed through the opening and into at least one threaded opening of a die thread. In this manner, the die thread can be removably attached to the adapter.

The adapter is also comprised of at least one socket that extends from the bottom member that allows the adapter to attach to an impact tool, a drill, etc. In this manner, the tool can be used to rotate the thread around a pipe to thread said pipe to eliminate the need for a user to manually rotate the die thread around said pipe to achieve the same. The die thread is comprised of at least one opening that allows a pipe to be placed into the thread. The interior of the thread is comprised of at least one thread-cutting member of any thread pitch, size, configuration, etc. When rotated around a pipe, the member cuts threads into the pipe.

The present invention is also comprised of a method of using the device. First, a device is provided comprised of at least one fastener, at least one adapter comprised of at least one opening and at least one socket, a die thread comprised of at least one fastener opening, at least one opening, and at least one thread-cutting member. Then, the die thread can be attached to the adapter by placing the fastener through the opening of the adapter and securing the fastener into the opening of the die thread. Next, the socket can be used to attach the device to an impact socket, a drill, etc. Finally, a pipe end can be inserted into an opening of the die thread, wherein the impact tool can be spun to cause the thread to spin around the pipe end such that the thread-cutting member cuts at least one thread into the pipe end.

Accordingly, the pipe threading device of the present invention is particularly advantageous as it provides an improved device for pipe threading. More specifically, the device can be used to thread pipes in tight spaces. While doing so, the device does not require significant physical exertion to use. In this manner, the pipe threading device overcomes the limitations of existing pipe threading devices and methods known in the art.

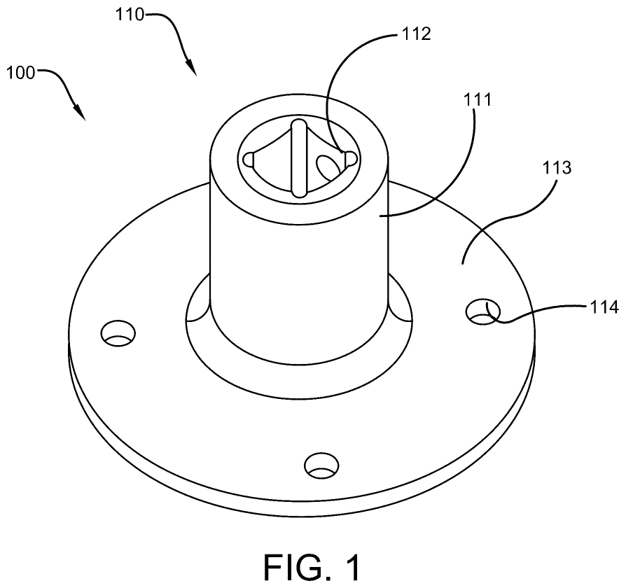

Referring initially to the drawings, FIG. 1 illustrates a perspective top view of an adapter of one potential embodiment of a pipe threading device 100 of the present invention in accordance with the disclosed architecture. The device 100 is comprised of an adapter 110 that can be used to attach a die thread 120 to an impact tool 10, drill, etc. As a result, the thread 120 can be used to thread a pipe without having to manually operate the thread 120.

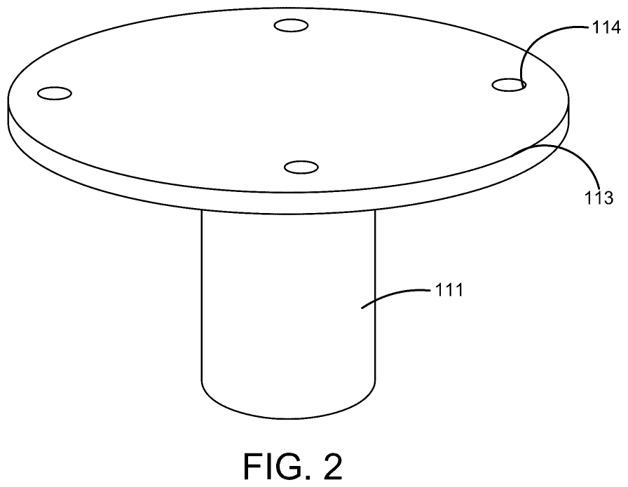

The adapter 110 is preferably made from a metal or rigid plastic material. The adapter 110 may be any size, shape, and configuration in different embodiments. In the preferred embodiment, the adapter 110 is comprised of a flat bottom member 113, as best seen in FIG. 2. The member 113 is preferably circular but may be any shape and size. The bottom member 113 is comprised of at least one opening 114. In the preferred embodiment, the bottom member 113 has a plurality of openings 114 of any size, spacing, arrangement, etc. In one embodiment, the bottom member 113 has multiple openings 114 arranged in patterns and sizes that can receive various die thread 120 types and sizes.

The openings 114 of the bottom member 113 allow at least one fastener 130, such as, but not limited to, a screw or a bolt, to be placed through the opening 114 and into at least one threaded opening 124 of a die thread 120. In this manner, the die thread 120 can be removably attached to the adapter 110.

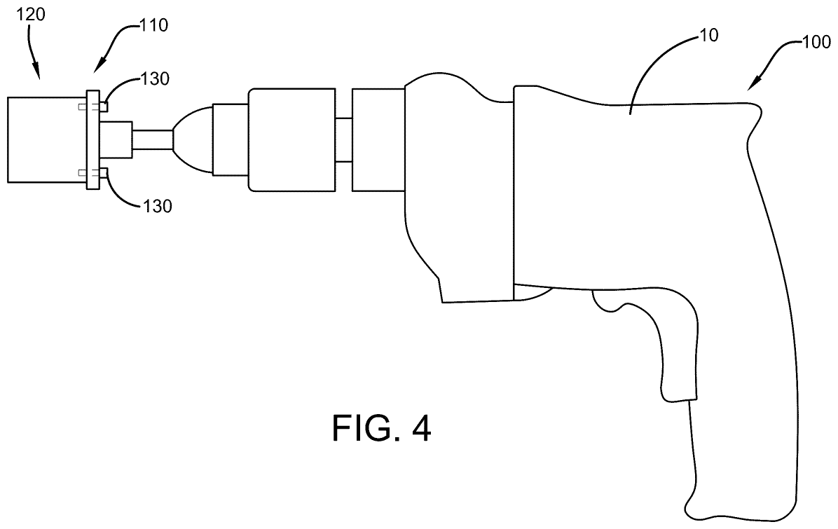

The adapter 110 is also comprised of at least one socket 111 that extends from the bottom member 113. The socket 111 may be any size, shape, and configuration of socket 111 having any type of female socket opening 112 that allows the adapter 110 to attach to an impact tool 10, a drill, etc., as seen in FIG. 4. Said openings include, but are not limited to, a hex socket, a double hex socket, a Torx socket, a square sock, a spline socket, a Phillips socket, etc. In this manner, the tool 10 can be used to rotate the thread 120 around a pipe to thread said pipe. This eliminates the need for a user to manually rotate the die thread 120 around said pipe to achieve the same.

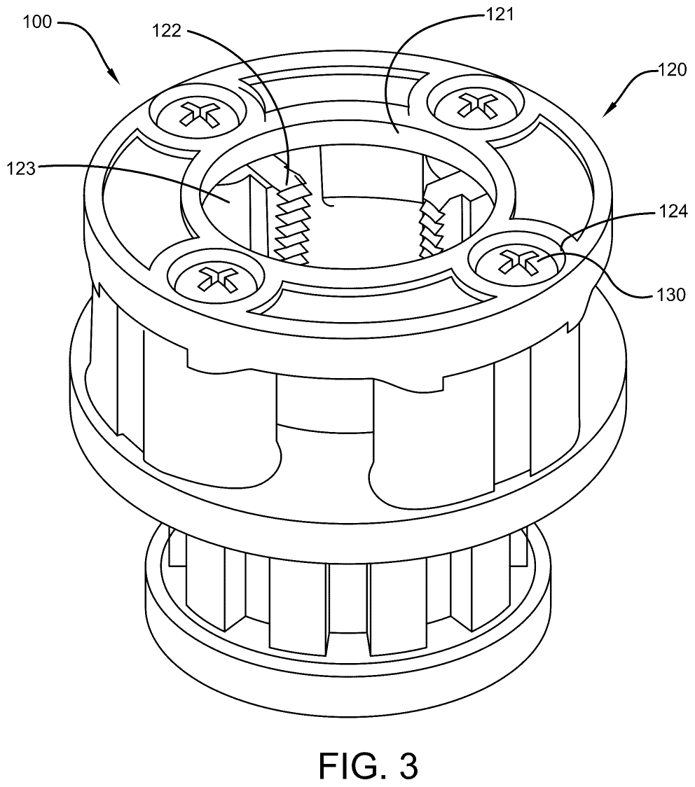

As seen in FIG. 3, the die thread 120 is comprised of at least one opening 121 that allows a pipe to be placed into the thread 120. The thread 120 may be any size, shape, and configuration of die thread 120 known in the art. The interior surface 123 of the thread 120 is comprised of at least one thread-cutting member 122 of any thread pitch, size, configuration, etc., that extends outwards from the interior surface 123. When rotated around a pipe, the member 122 cuts threads into the pipe.

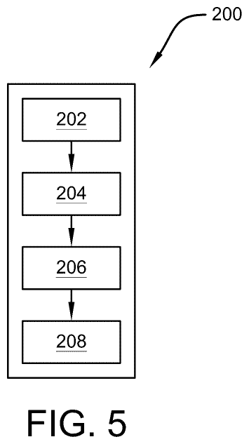

The present invention is also comprised of a method of using 200 the device 100, as seen in FIG. 5. First, a device 100 is provided comprised of at least one fastener 130, at least one adapter 110 comprised of at least one opening 114 and at least one socket 111, a die thread 120 comprised of at least one fastener opening 124, at least one opening 121, and at least one thread-cutting member 122 [Step 202]. Then, the die thread 120 can be attached to the adapter 110 by placing the fastener 130 through the opening 114 of the adapter 110 and securing the fastener 130 into the opening 124 of the die thread 120 [Step 204]. Next, the socket 111 can be used to attach the device 100 to an impact socket, a drill, etc. [Step 206]. Finally, a pipe end can be inserted into an opening 121 of the die thread 120, wherein the impact tool 10 can be spun to cause the thread 120 to spin around the pipe end such that the thread-cutting member 122 cuts at least one thread into the pipe end [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “pipe threading device” and “device” are interchangeable and refer to the pipe threading device 100 of the present invention.

Notwithstanding the foregoing, the pipe threading device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the pipe threading device 100 as shown in the FIGS. are for illustrative purposes only, and that many other sizes and shapes of the pipe threading device 100 are well within the scope of the present disclosure. Although the dimensions of the pipe threading device 100 are important design parameters for user convenience, the pipe threading device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pipe threading device comprising:
an adapter comprised of:
a socket comprised of a first opening; and
a bottom member comprised of a second opening.

2. The pipe threading device of claim 1, wherein the bottom member is comprised of a circular shape.

3. The pipe threading device of claim 2, wherein the bottom member is flat.

4. The pipe threading device of claim 1, wherein the socket is comprised of a hex socket, a double hex socket, a Torx socket, a square sock, a spline socket, and a Phillips socket.

5. A pipe threading device comprising:
a fastener;
an adapter comprised of:
a socket comprised of a first opening; and
a bottom member comprised of a second opening;
a die thread comprised of:
a third opening;
a thread-cutting member; and
a fastener opening.

6. The pipe threading device of claim 5, wherein the bottom member is comprised of a circular shape.

7. The pipe threading device of claim 6, wherein the bottom member is flat.

8. The pipe threading device of claim 5, wherein the socket is comprised of a hex socket, a double hex socket, a Torx socket, a square sock, a spline socket, and a Phillips socket.

9. The pipe threading device of claim 5, wherein the thread-cutting member is positioned on an interior surface of the die thread.

10. The pipe threading device of claim 9, wherein the thread-cutting member extends outwards from the interior surface.

11. The pipe threading device of claim 5, wherein the fastener opening is comprised of a threaded opening.

12. The pipe threading device of claim 5, wherein the fastener is comprised of a screw.

13. The pipe threading device of claim 5, wherein the fastener is comprised of a bolt.

14. A method of using a pipe threading device, the method comprising the following steps:
providing a pipe threading device comprised of a fastener, an adapter comprised of a first opening and a socket, and a die thread comprised of a fastener opening, a second opening, and a thread-cutting member;
attaching the die thread to the adapter by placing the fastener through the first opening and into the fastener opening;
attaching the pipe threading device to a tool via the socket; and
inserting a pipe end into the second opening and using the tool to rotate the pipe threading device around the pipe end to create a thread.

15. The method of using a pipe threading device of claim 14, wherein the adapter is comprised of a bottom member.

16. The method of using a pipe threading device of claim 15, wherein the bottom member is flat.

17. The method of using a pipe threading device of claim 14, wherein the socket is comprised of a hex socket, a double hex socket, a Torx socket, a square sock, a spline socket, and a Phillips socket.

18. The method of using a pipe threading device of claim 14, wherein the thread-cutting member is positioned on an interior surface of the die thread.

19. The method of using a pipe threading device of claim 18, wherein the thread-cutting member extends outwards from the interior surface.

20. The method of using a pipe threading device of claim 14, wherein the fastener opening is comprised of a threaded opening.
